(19) United States
(12) Patent Application Publication
(10) Pub. No.: US 2015/0278401 A1
(43) Pub. Date: Oct. 1, 2015

(54) INTELLIGENT OFFSET RECOGNITION IN CAD MODELS

(71) Applicant: SIEMENS PRODUCT LIFECYCLE MANAGEMENT SOFTWARE INC., Plano, TX (US)

(72) Inventors: Howard Charles Duncan Mattson, Cambridge (GB); Douglas Joseph King, Peterborough (GB); Yanong Zhu, Cambridge (GB)

(73) Assignee: SIEMENS PRODUCT LIFECYCLE MANAGEMENT SOFTWARE INC., Plano, TX (US)

(21) Appl. No.: 14/229,041

(22) Filed: Mar. 28, 2014

(51) Int. Cl. G06F 17/50

(52) U.S. Cl. CPC G06F 17/50

(57) ABSTRACT

Systems and methods for identifying members of offset pairs in CAD models. A method includes receiving a CAD model that includes a plurality of entities each having an underlying geometry. The method includes identifying a first offset pair chain corresponding to a first entity of the plurality of entities, including identifying a first partner entity that is part of the same offset pair. The method includes determining whether the first offset pair chain is a strong chain. The method includes when the first offset pair chain is a strong chain, then marking the first entity as a part of an offset pair. The method includes storing the CAD model including the marked first entity.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

PDM systems manage PLM and other data, and CAD systems are useful for modeling. Improved systems are desirable.

### SUMMARY OF THE DISCLOSURE

Various disclosed embodiments include systems and methods for identifying members of offset pairs in CAD models. A method includes receiving a CAD model that includes a plurality of entities each having an underlying geometry. The method includes identifying a first offset pair chain corresponding to a first entity of the plurality of entities, including identifying a first partner entity that is part of the same offset pair. The method includes determining whether the first offset pair chain is a strong chain. The method includes, when the first offset pair chain is a strong chain, then marking the first entity as a part of an offset pair. The method includes storing the CAD model including the marked first entity.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates examples of geometric offsets between underlying geometries in accordance with disclosed embodiments;

FIG. 3 illustrates offset pairs in accordance with disclosed embodiments;

FIGS. 4A-4F illustrate connected offset pairs in accordance with disclosed embodiments;

FIGS. 5A-5C illustrate examples of offset chains in accordance with disclosed embodiments;

FIG. 6 illustrates a flowchart of a process in accordance with disclosed embodiments;

FIGS. 7A and 7B illustrate an example of a CAD model in accordance with disclosed embodiments;

FIG. 8 illustrates an example of a thin-wall characteristic in accordance with disclosed embodiments;

FIG. 9 illustrates an example of vanishing partners in accordance with disclosed embodiments;

FIGS. 10A and 10B illustrate vanishing overlaps in accordance with disclosed embodiments; and

FIG. 11 illustrates entities in multiple chains in accordance with disclosed embodiments.

### DETAILED DESCRIPTION

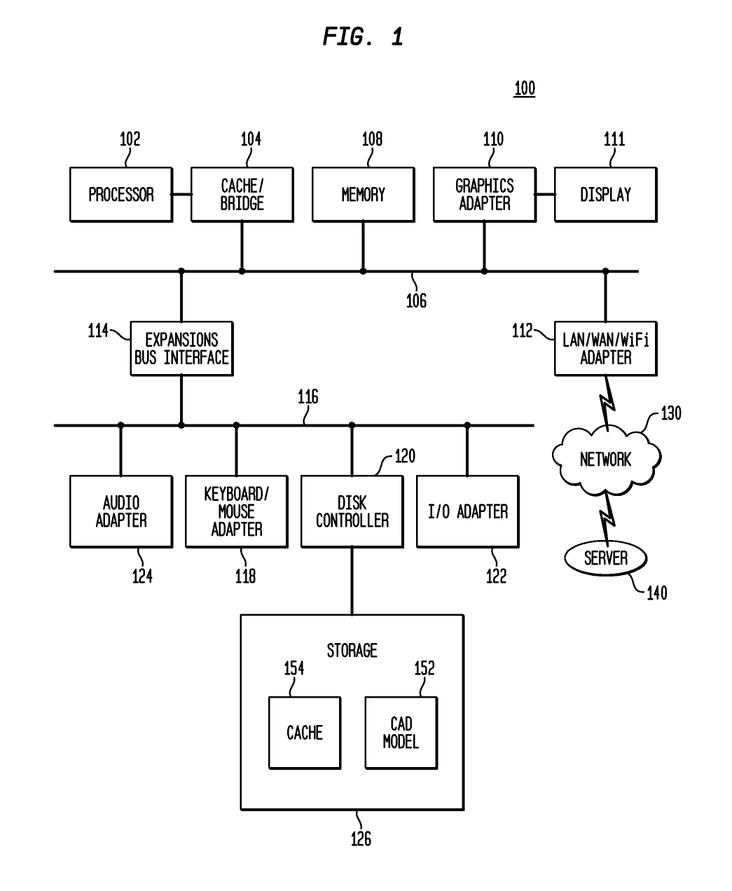

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In the context of two-dimensional (2D) or three-dimensional (3D) geometric models, it is often useful for a system to be able to automatically recognize those pairs of offset geometries that a user might reasonably wish to maintain or otherwise process. That is, a model will often include two geometries, such as a line, curve, or object, that are offset from each other by a fixed distance. In many cases, this offset relationship should be maintained in the model while other operations are being performed. Disclosed embodiments include intelligent systems and methods for automatic recognition and processing of such offset relationships.

Basic low level detection of the geometric offset condition can be performed by some systems, for example by simply recognizing that two geometries are constrained to a set distance from each other. Other systems can identify wall features in object models by identifying counterpart wall faces, such as described in commonly-assigned U.S. Pat. No. 8,260,583, incorporated herein by reference.

However, many systems will either not recognize offset relations without specific constraints or will identify too many pairs of geometries as having an offset relationship simply because they are proximate to each other. Over-recognition of offset “pairs” is particularly problematic since it results in a slow and unproductive user interaction with the system. Disclosed embodiments employ heuristic intelligence techniques to determine which offset pairs should be recognized.

FIG. 1 depicts a block diagram of a data processing system in which an embodiment can be implemented, for example as a CAD or PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can store any data necessary for operation as described herein, including CAD model 152 and cache 154, discussed in more detail below.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods for intelligently identifying and processing “realistic” offset geometries, and can be implemented as an overall flexible framework into which further heuristics can be added. As used herein, “realistic” offsets refer to those that correspond to offset geometries as a human user would regard them. Various embodiments can operate in different modes, including a batch/global mode for recognizing all realistic offsets in a model and storing this information for subsequent use, and a local, selection-driven, on-the-fly mode for interactive operations only requiring the minimum of offset pairs to be found.

Various embodiments can use absolute or context-independent criteria, so that the decision of whether an entity is or is not an offset will always be the same regardless of whether batch or selection mode is being used and is independent of any processing order. In various embodiments, chains of connected offsets can be considered together, which is more aligned with the way humans judge offsets in typical models. Further, while not limited to this bias, various embodiments can favor chains of offsets containing some “long and thin” pairs as these are typical in thin-wall and clearance situations in CAD modeling.

For consistency of description, various terms have specific usage in this document. An “entity” refers to a bounded portion of an underlying geometry. In 2D implementations, the entity is an edge and the underlying geometry is a curve, while in 3D implementations, the entity is a face and the underlying geometry is a surface.

A “geometric offset” exists between the underlying geometries of two entities when each underlying geometry is the same distance from the other underlying geometry at all corresponding points. These two entities are referred to herein as an “offset pair” and each entity in the pair may be referred to as the “partner” of the other. In 2D implementations, an offset pair could consist, for example, of parallel lines, concentric circles, approximate spline curve offsets, or a base curve and a procedurally defined offset curve:

OffsetCurve(t)=BaseCurve(t)+distance*NormalToBaseCurve(t)

In 3D implementations, an offset pair could consist of, for example, parallel planes, concentric spheres, coaxial cylinders, same spine tori, coaxial and same angle cones, approximate spline surface offsets, or a base surface and a procedurally defined offset surface:

OffsetSurface(t)=BaseSurface(t)+distance*NormalToBaseSurface(t)

FIG. 2 illustrates examples of geometric offsets between underlying geometries of two parallel lines (top row) and two concentric circles (bottom row). In this figure, the entities 202 are shown with solid lines while their respective underlying geometries 204 are shown with dashed lines. This figure illustrates that the one entity can completely overlap the other entity (first column), partially overlap the other (second column), or the entities may not overlap each other at all (third column) where the underlying geometries for each entity have a geometric offset.

As used herein, an “overlap” exists between two geometric offset entities when there is at least one point of projection between the two entities. In FIG. 2, a normal from the surface of one entity can be projected onto the other entity in the first and second columns, but not in the third column. Thus, the entities of the first and second columns have an overlap but the entities of the third column do not have an overlap.

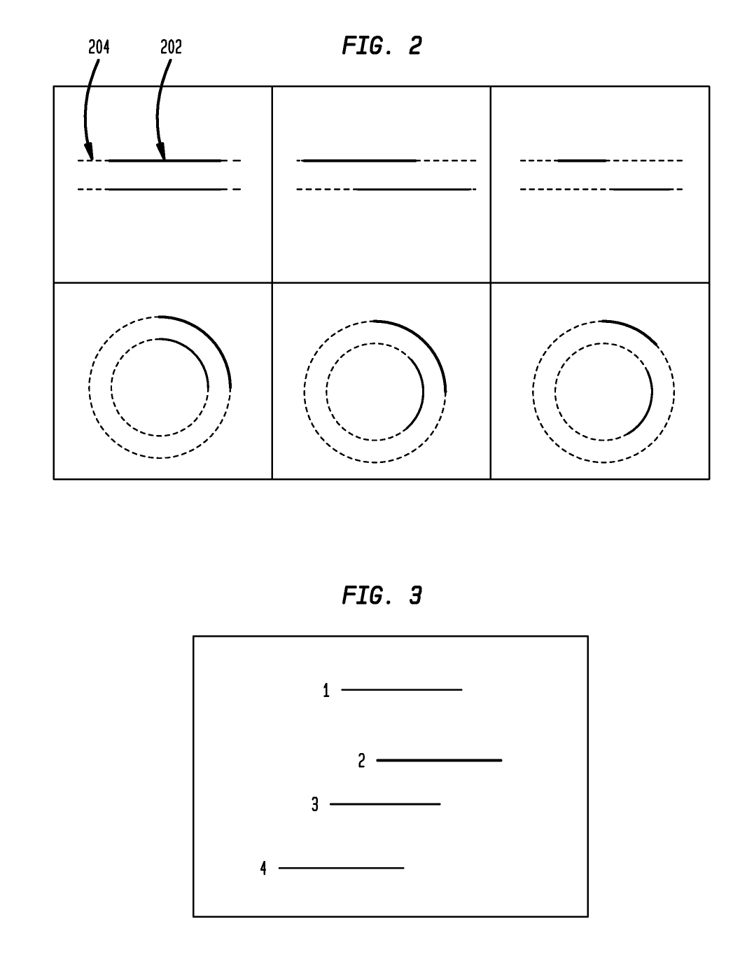

An “offset pair” refers to two entities which are the nearest overlapping geometric offsets of each other. FIG. 3 illustrates offset pairs in accordance with disclosed embodiments. In this example, only entities 2 and 3 form an offset pair as they are the only combination where each is the nearest overlapping geometric offset to the other.

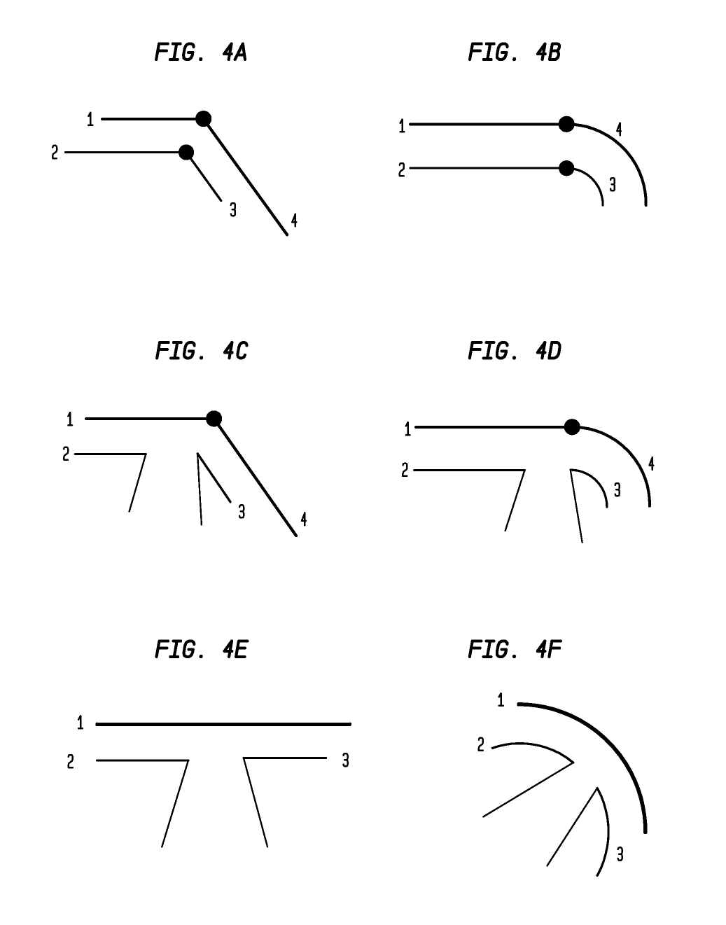

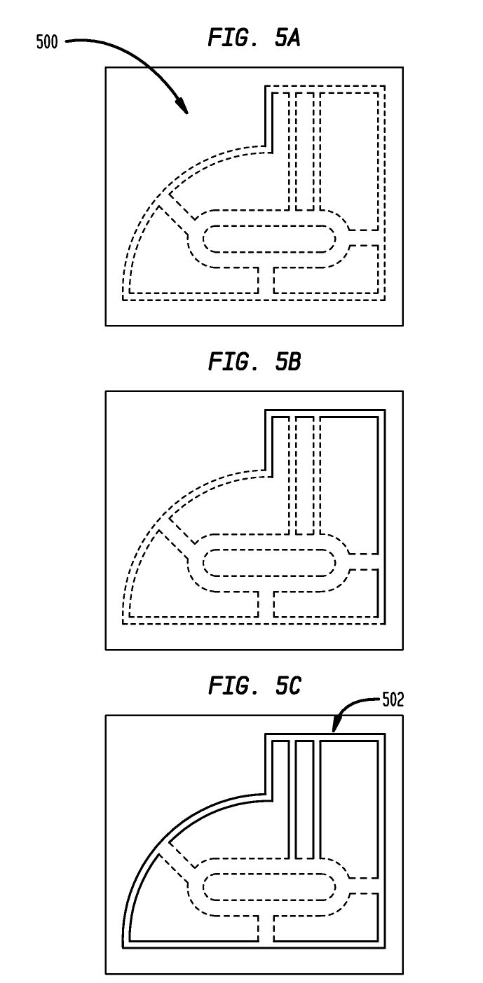

As used herein, two offset pairs or offset pair chains are “connected” if they have the same offset distance and have an adjacency between entities on the same side or share an entity on the same side. FIGS. 4A-4F illustrate connected offset pairs in accordance with disclosed embodiments.

FIGS. 4A-4D illustrate examples of the connection through adjacency. In each of these examples, entities 1 and 2 are a first offset pair and entities 3 and 4 are a second offset pair. These offset pairs are connected since entities 1 and 4 are adjacent to each other in each example, and entities 2 and 3 are adjacent to each other in the examples of FIGS. 4A and 4B. Adjacency on 1 side is sufficient for a connection.

FIGS. 4E-4F illustrate examples of the connection through sharing. In each of these examples, entities 1 and 2 are an offset pair and entities 1 and 3 are also an offset pair. These offset pairs are connected since entities 2 and 3 each form an offset pair with the “shared” entity 1.

An “offset chain” or “offset pair chain” as used herein is one or more connected offset pairs. FIGS. 5A-5C illustrate examples of offset chains 502 shown as solid lines in a CAD model 500 while remaining entities are shown as dashed lines. FIG. 5A illustrates a minimal offset chain, including only a single offset pair. FIG. 5B illustrates a partial offset chain of several connected offset pairs, but not including all of the offset pairs connected to those shown. FIG. 5C illustrates a complete offset chain, where the complete chain of offset pairs is shown in solid lines.

Disclosed embodiments can designate entities as “realistic” offsets if they are part of a “strong” offset chain. The strength or weakness of a chain can be judged by using many and multiple measures.

In some cases, an offset chain can be considered “strong” if it is long and thin. This measure encodes the human interpretation of wall-like and slot-like portions of a model as being stronger than distant or short sections of possible offset. In various embodiments, this measure is made on individual pairs and a chain is deemed strong if at least one pair is strong. It can also be applied to the chain as a whole. The measure is a ratio of the length of the overlap to the offset distance value. In 2D implementations, the length of overlap is calculated as the overlapping portions of edges. In 3D implementations, the length would be formed by any reasonable length measure of overlap such as a diagonal of an overlap box. A variable threshold can then be used to determine whether the pair is strong or not. In some embodiments, a ratio of 5:1 (length of overlap:offset) is used as a threshold to determine that the pair is strong, but other ratios can be used in other embodiments.

In some cases, an offset chain can be considered “strong” if it is explicitly labelled. If an offset pair is explicitly denoted as an offset pair, then it should be considered as strong.

In some cases, an offset chain can be considered less “strong” if it the offset pairs are “blocked” by other entities. Intervening entities within the overlap region may be regarded as weakening the strength of a pair or even disregarding it as a pair altogether. Whether this measure is used can depend heavily on the application domain and the particular implementation.

In some cases, an offset chain can be considered “strong” based on the geometric type of the geometries. Different geometric types may be considered stronger due to consideration of the rarity of their appearance. For example, spline geometries in approximate offset or procedural offset geometry are unlikely to be accidentally in offset, whereas lines and planes are often parallel and circles and cylinders are often concentric. This can be used as an explicit override of the strength measure or else to decrease the overlap ratio required for recognition.

In some cases, an offset chain can be considered “strong” based on specific values. Particular absolute values may be significant in some situations, either as explicitly entered by a user or perhaps a set of domain standard values might be known.

In some cases, an offset chain can be considered “strong” based on other implementation specifics. As described herein, disclosed techniques are flexible and any domain or implementation specifics can be used to infer a pair or whole chain as strong.

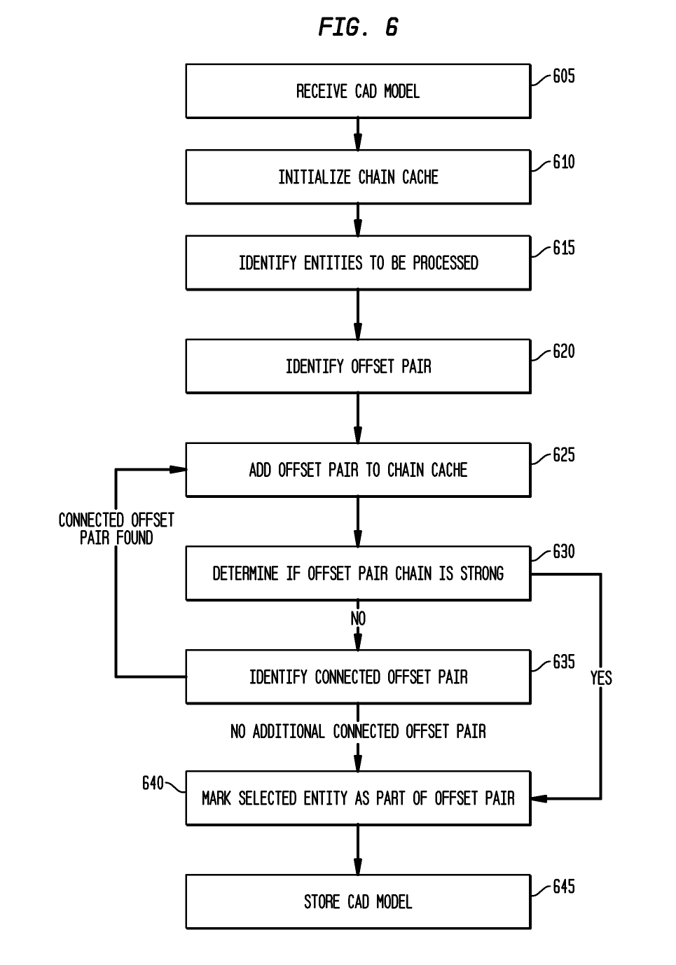

FIG. 6 depicts a flowchart of a process in accordance with disclosed embodiments that may be performed, for example, by one or more CAD systems as described herein, referred to generically as the “system.”

The system receives a CAD model (605), the CAD model including a plurality of entities each having an underlying geometry. Note that multiple entities may share an underlying geometry, such as two bounded line entities on the same underlying line geometry. The CAD model can be stored as CAD model 152. The CAD model can also store offset and chain information for some of the entities, including which entities are part of a strong offset chain, in which case those entities do not need to be re-processed as described herein.

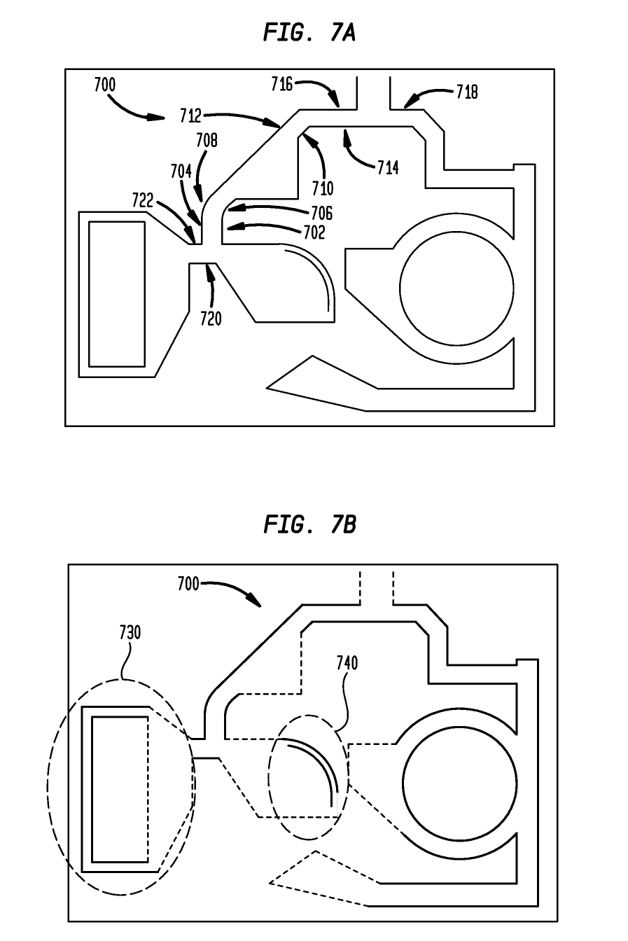

FIGS. 7A and 7B illustrate an example of a CAD model 700 that can be received that has a plurality of entities, such as entity 702 of FIG. 7A, each having an underlying geometry (not shown), and is used to illustrate the process of FIG. 6. While this example is a 2D CAD model representation, the processes described herein apply also to 3D CAD models.

The system can initialize a chain cache (610). The chain cache can record processed entities and their discovered chains. The chain cache can be stored as cache 154.

The system can identify the entities to be processed (615). This can be, for example, a single entity for on-the-fly mode or all entities in CAD model for batch mode. In the example of FIG. 7A, entity 702 is selected as the entity to be processed, and the application or user needs to know whether to treat the selected entity 702 as an offset. Identifying the entity to be processed can include receiving a user selection of one or more entities to be processed.

For each entity to be processed, if the entity is not already in an offset pair stored in the cache, the system identifies an offset pair (620). As part of 620, the system determines if the entity is part of an offset pair (620), including identifying at least one partner entity. If the current entity is not part of an offset pair, then no further processing is needed for that entity since it is not part of an offset pair chain. In the example of FIG. 7A, entity 704 is identified as an offset entity to entity 702, and entities 702 and 704 comprise an offset pair and an offset pair chain (since an offset pair chain need have only one offset pair).

The system adds the offset pair to the chain cache (625) as an offset pair chain. The system can form a new chain in the cache with this immediate offset pair or add this offset pair chain to a connected offset pair chain already stored in the cache (when the process repeats as described below).

The system can determine if the offset pair chain is a strong chain (630). If the offset pair chain is a strong chain, then the offset pair chain is marked as strong in the cache. In the on-the-fly mode case, processing can proceed to 640 as soon as the offset pair chain is marked as a strong chain, since the entity 702 is therefore determined to be a recognized offset and the chain marked as strong in the cache. In a batch mode, all entities will generally be processed in any case.

In the example of FIG. 7A, the overlap between entities 702 and 704 is insufficient in ratio to the offset distance, however, so this chain is not strong in the first pass.

The system can identify an additional offset pair that is connected to the offset pair chain stored in the cache (635), and the process repeats to 625. If there are no further connected offset pairs, then the process proceeds to 640.

In the example of FIG. 7A, entities 706 and 708 are identified as a connected offset pair after the first pass; this offset pair is also not strong. In further iterations, entities 710 and 712 are added to the offset pair chain as a connected offset pair, but they are not strong. Entities 720 and 722 are added to the offset pair chain as a connected offset pair, but they are not strong. Entities 714 and 716 are added to the offset pair chain as a connected offset pair, but they are not necessarily strong (depending on the overlap/distance ratio used). Entities 714 and 718 are added to the offset pair chain as a connected offset pair, but they are not necessarily strong (depending on the overlap/distance ratio used). However, when the overlap of entities 716 and 718 with entity 714 are combined, as described in more detail below, it is clear that there is a strong offset pair chain.

The system marks the selected entity as part of an offset pair if it is part of a strong chain (640). If it is not part of a strong chain, then the selected entity is not marked as part of an offset pair. Note that it is not necessary to find the whole chain in order to determine the outcome for the selected entity. In the example of FIG. 7A, once the strong offset pair chain is identified, entity 702 is marked as part of an offset pair.

The system stores the CAD model including the marked entity (645). Any of the offset pair, offset pair chain, or other information described above can also be stored.

Of course, those of skill in the art will recognize that, unless specifically indicated or required by the sequence of operations, certain steps in the processes described above may be omitted, performed concurrently or sequentially, or performed in a different order.

FIG. 7B illustrates the results of a batch-mode process performed as described above. The batch mode would have recognized three full chains in model 700, shown as solid lines in FIG. 7B, while non-chain entities are shown in dashed lines. In this figure, one chain is the solid lines indicated at 730, another chain is the solid lines indicated at 740, and the final chain is the remaining solid lines.

In various embodiments, the system considers the combination of multiple entities in overlap calculations. When offset pairs share an entity, such as where entities 716 and 718 share entity 714 in FIG. 7A, the calculation of the offset ratio can be improved by summing the overlap of all the pairs. This case occurs often as a result of splitting one side of a single offset pair and is often how a human perceives the case. In the example of FIG. 7A, as described above, the sum of the overlaps between entities 714/716 and 714/718 is compared to the offset difference, which results in a much larger ratio for considering whether a strong offset chain is formed. Such a combination is not limited to two entities that share another entity; any number of entities that share a common entity can be combined for such an overlap calculation. That is, the overlap can be calculated based on a ratio of (i) a sum of the lengths by which the first entity and at least one other entity that shares the first partner entity overlap the first partner entity to (ii) an offset distance between the first entity and the first partner entity

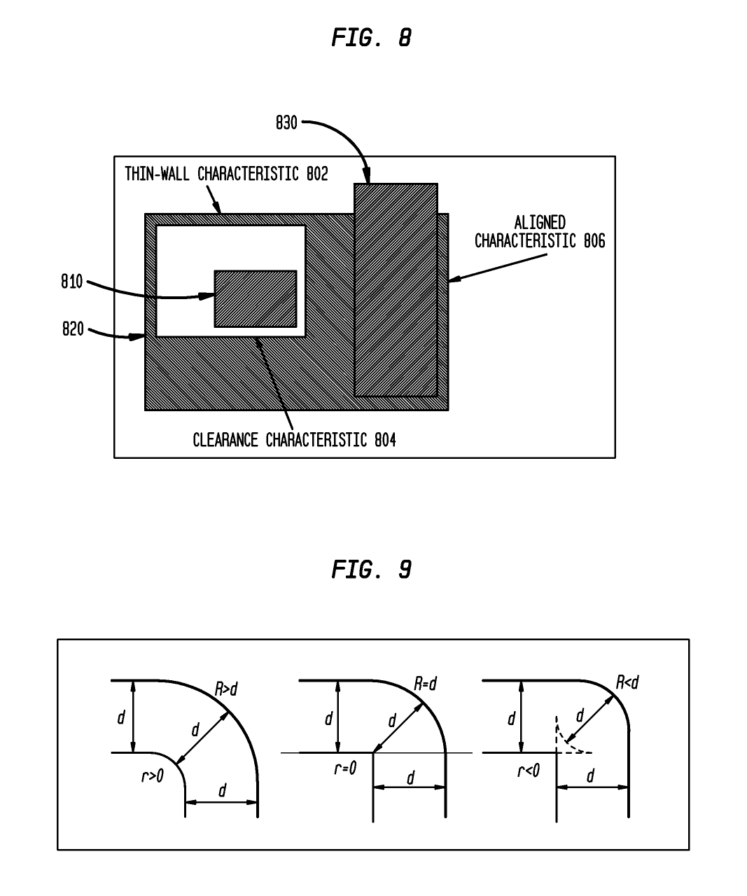

Various embodiments can also filter offset pairs. In some implementations and for some domains, it may be required to only recognize some subsets of offsets. For example, if a particular meaning can be assigned to each side of the entities, such as “inside” and “outside,” then offsets with the characteristics of thin walls or inter-wall clearance gaps may be required whereas other combinations, where the sides are aligned, may not be useful. FIG. 8 illustrates an example of a thin-wall characteristic 802, where the entity pair forms a thin wall within object 820. FIG. 8 also illustrates an example of a clearance characteristic 804, where the entity pair represents the offset between the contained object 810 and the containing object 820. FIG. 8 also illustrates an example of an aligned characteristic 806, where the entity pair represents the aligned offset between borders of the object 830 and the object 820. Any given pairs of entities can be filtered to be included or excluded from the process based on such characteristics.

In various embodiments, the system can process vanishing partners. A general issue when dealing with offsets is when the radius of curvature becomes equal to and then smaller than the offset distance. When it becomes equal, the partner entity collapses into a point of zero radius and when it decreases further, the partner radius effectively becomes negative and is not represented in the real portion of the model.

FIG. 9 illustrates an example of vanishing partners as the radius is decreased, left to right. In the left illustration, the radius R of the outer entity curvature is greater than the distance d between the inner entity and the outer entity, and so the radius r of the inner entity curvature is greater than zero. In the middle illustration, R is equal to d, and r is equal to 0 (where d is kept constant), so the inner entity has collapsed to a point. In the right illustration, R is less than d, so r is less than 0 (where d is kept constant); the inner entity has vanished from the visible model altogether.

As this is a fairly common situation, various offset recognition processes as described herein explicitly detect this by consideration of the neighboring geometry. An offset pair with a virtual partner (that is, created in the model but not visible in the model) and zero or negative radius is used to represent this situation allowing the pair to be part of an offset chain. When the model is subsequently edited and the larger radius increased or the distance decreased (right to left in the figure), the partner radius may become positive again and can reappear in the model.

In various embodiments, the system can process vanishing overlaps. When the length of a candidate offset entity pair becomes smaller than the value of the offset distance, the overlap will vanish.

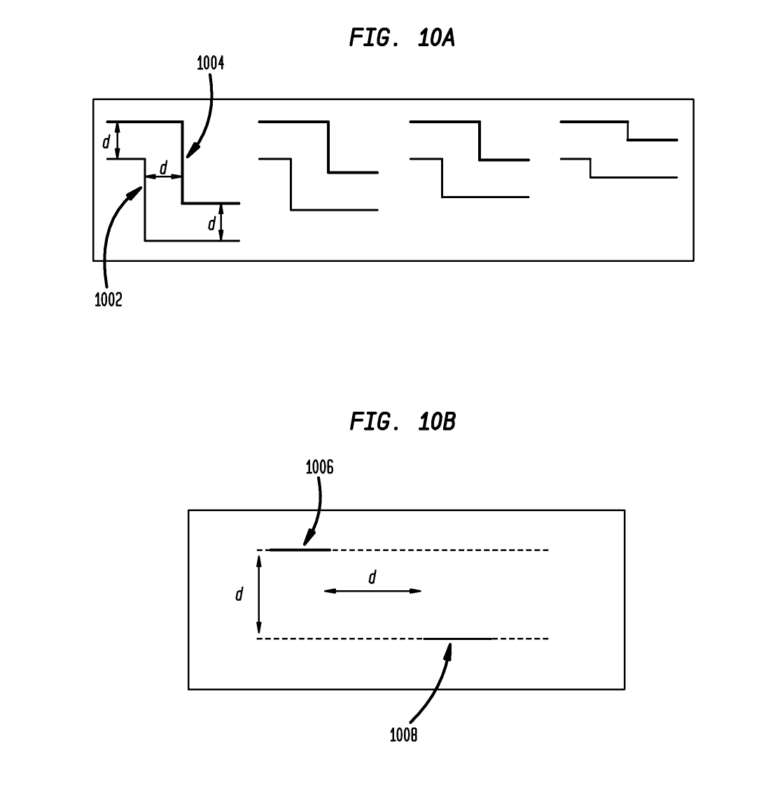

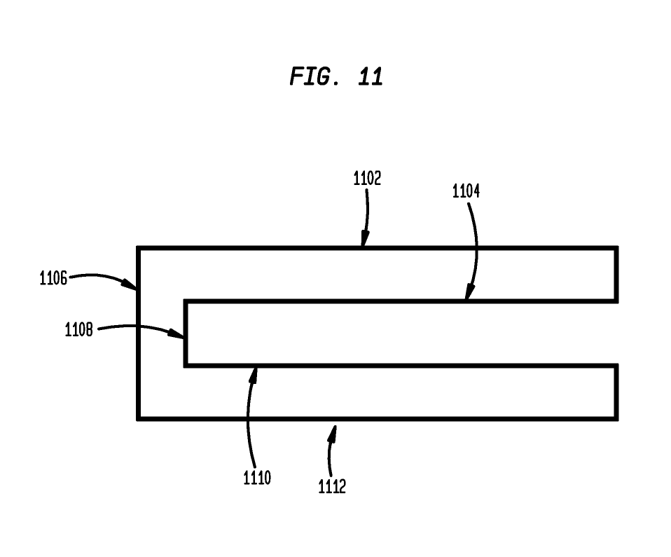

FIGS. 10A and 10B illustrate vanishing overlaps in accordance with disclosed embodiments. Example of vanishing overlap when entities are small compared to the offset value. In the example of FIG. 10A, note that in the leftmost illustration entities 1002 and 1004 in the offset chain overlap. As entities 1002 and 1004 are viewed as progressively smaller, the overlap disappears, so that no overlap is seen in the rightmost illustration. Given that the distance d is constant, a user would often desire for the left most case to still be considered as an offset pair chain.

To address this, the system can define the “overlap” requirement to include gaps of up to the offset distance. FIG. 10B illustrates an example of allowing an offset pair when there is a distance gap in the overlap. In this case, the gap in the overlap between entities 1006 and 1008 is less than the distance d of the offset, so the system can consider these to be overlapping when identifying offset pairs.

Note that this does not need to imply that the strength measure is changed at all, as this pair should still generally not be considered strong. It is sufficient to include the pair in the basic check and allow strength to be required elsewhere in the chain.

In various embodiments, the system can process explicit labels. The presence of an explicit label that indicates that a pair should be considered as an offset pair, at least in the local editing usage, would generally be expected to result in the pair being included in the processing as an offset pair, regardless of whether it met the overlap or nearest neighbor requirements. Note that this is not to be confused with the previous mention of explicit labelling as enhancing the strength measure of an otherwise valid offset pair.

In various embodiments, the system can process multiple chains for the same entity. The algorithm framework is capable of handling entities being in multiple chains. FIG. 11 illustrates entities in multiple chains. For example, in this figure, a first offset chain could include entities 1102/1106/1112 and their partner entities 1104/1108/1110. A second offset chain could include entity 1104 and partner entity 1110. This can be true whether or not the offset distance between the pairs in the first offset chain is the same as or is different from the distance between the pairs in the second offset chain. This inclusion is preferably limited to avoid over finding of offset pairs, and so the system can use an implementation-specific heuristics and domain knowledge to limit finding excess pairs.

In various embodiments finding pairs with the characteristic long and thin seeds make the whole chain recognized, and finding pairs as offsets which would be weak, in isolation, are counted as offsets due to chain connection. Various embodiments can find those offset pairs that are nearest overlapping offsets of each other, and can avoid finding offset pairs when there are blocking entities.

Various embodiments can use domain knowledge and implementation extensions within the framework of the disclosed techniques, including in the basic detection of the offset pair condition, in the filtering of unwanted offset pairs, in the connection types for building chains, and in strength indicators for pairs and chains as a whole.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for product data management, the method performed by a data processing system and comprising:
receiving a CAD model that includes a plurality of entities each having an underlying geometry;
identifying a first offset pair chain corresponding to a first entity of the plurality of entities, including identifying a first partner entity that is part of the same offset pair;
determining whether the first offset pair chain is a strong chain, and when the first offset pair chain is a strong chain, then marking the first entity as a part of an offset pair; and
storing the CAD model including the marked first entity.

2. The method of claim 1, wherein the system also identifies a first partner entity to the first entity, the first entity and the first partner entity comprising the offset pair chain.

3. The method of claim 1, wherein when the first offset pair chain is not a strong chain, then the system identifies an additional offset pair that is connected to the first offset pair chain, and repeats the determining, marking, and storing steps using the additional offset pair.

4. The method of claim 1, wherein the first offset pair chain is determined to be a strong chain based on a ratio of a length of an overlap between the first entity and the first partner entity to an offset distance between the first entity and the first partner entity.

5. The method of claim 1, wherein the first offset pair chain is determined to be a strong chain based on an explicit label of an offset pair.

6. The method of claim 1, wherein the first offset pair chain is determined to be a strong chain based on geometric types of the underlying geometries of the first entity and the first partner entity.

7. The method of claim 1, wherein the first offset pair chain is determined to be a strong chain based on a ratio of
a sum of lengths by which the first entity and at least one other entity that shares the first partner entity overlap the first partner entity to
an offset distance between the first entity and the first partner entity.

8. A data processing system comprising:
a processor; and
an accessible memory, the data processing system particularly configured to
receive a CAD model that includes a plurality of entities each having an underlying geometry;
identify a first offset pair chain corresponding to a first entity of the plurality of entities, including identifying a first partner entity that is part of the same offset pair;
determine whether the first offset pair chain is a strong chain, and mark the first entity as a part of an offset pair when the first offset pair chain is a strong chain; and
store the CAD model including the marked first entity.

9. The data processing system of claim 8, wherein the system also identifies a first partner entity to the first entity, the first entity and the first partner entity comprising the offset pair chain.

10. The data processing system of claim 8, wherein when the first offset pair chain is not a strong chain, then the system identifies an additional offset pair that is connected to the first offset pair chain, and repeats the determining, marking, and storing steps using the additional offset pair.

11. The data processing system of claim 8, wherein the first offset pair chain is determined to be a strong chain based on a ratio of a length of an overlap between the first entity and the first partner entity to an offset distance between the first entity and the first partner entity.

12. The data processing system of claim 8, wherein the first offset pair chain is determined to be a strong chain based on an explicit label of an offset pair.

13. The data processing system of claim 8, wherein the first offset pair chain is determined to be a strong chain based on geometric types of the underlying geometries of the first entity and the first partner entity.

14. The data processing system of claim 8, wherein the first offset pair chain is determined to be a strong chain based on a ratio of
a sum of lengths by which the first entity and at least one other entity that shares the first partner entity overlap the first partner entity to
an offset distance between the first entity and the first partner entity.

15. A non-transitory computer-readable medium encoded with executable instructions that, when executed, cause one or more data processing systems to:
receive a CAD model that includes a plurality of entities each having an underlying geometry;
identify a first offset pair chain corresponding to a first entity of the plurality of entities, including identifying a first partner entity that is part of the same offset pair;
determine whether the first offset pair chain is a strong chain, and mark the first entity as a part of an offset pair when the first offset pair chain is a strong chain; and
store the CAD model including the marked first entity.

16. The computer-readable medium of claim 15, wherein the system also identifies a first partner entity to the first entity, the first entity and the first partner entity comprising the offset pair chain.

17. The computer-readable medium of claim 15, wherein when the first offset pair chain is not a strong chain, then the system identifies an additional offset pair that is connected to the first offset pair chain, and repeats the determining, marking, and storing steps using the additional offset pair.

18. The computer-readable medium of claim 15, wherein the first offset pair chain is determined to be a strong chain based on a ratio of a length of an overlap between the first entity and the first partner entity to an offset distance between the first entity and the first partner entity.

19. The computer-readable medium of claim 15, wherein the first offset pair chain is determined to be a strong chain based on an explicit label of an offset pair.

20. The computer-readable medium of claim 15, wherein the first offset pair chain is determined to be a strong chain based on geometric types of the underlying geometries of the first entity and the first partner entity.
